(19) United States
(12) Patent Application Publication
(10) Pub. No.: US 2025/0168496 A1
(43) Pub. Date: May 22, 2025

(54) ELECTRONIC DEVICE, METHOD, AND NON-TRANSITORY COMPUTER-READABLE STORAGE MEDIUM FOR USER INTERFACE FOR PHOTOGRAPHING

(71) Applicant: Samsung Electronics Co., Ltd., Suwon-si (KR)

(72) Inventors: Taewon EOM, Suwon-si (KR); Kwanghyun JANG, Suwon-si (KR); Jaehan LEE, Suwon-si (KR)

(21) Appl. No.: 19/029,298

(22) Filed: Jan. 17, 2025

Related U.S. Application Data
(63) Continuation of application No. PCT/KR2023/007545, filed on Jun. 1, 2023.

(30) Foreign Application Priority Data
Jul. 17, 2022 (KR) 10-2022-0087868
Aug. 9, 2022 (KR) 10-2022-0099030

(51) Int. Cl. H04N 23/63; G06T 3/40; G06T 5/50; G06T 5/70

(52) U.S. Cl. CPC H04N 23/632; G06T 3/40; G06T 5/50; G06T 5/70; G06T 2207/20221

(57) ABSTRACT

An electronic device is provided. The electronic device includes a display, a plurality of cameras, memory storing one or more computer programs, and one or more processors including processing circuitry coupled to the display, the plurality of cameras, and the memory, wherein the one or more computer programs include computer-executable instructions that, when executed by the one or more processors individually or collectively, cause the electronic device to display, via the display, within a first region of a user interface (UI) for photographing, a first preview image of a first scene obtained through at least one of the plurality cameras at a first magnification lower than a reference magnification, and display, via the display, within a second region of the UI different from the first region, one or more thumbnail images respectively indicating one or more images obtained through at least one of the plurality cameras, while the first preview image and the one or more thumbnail images are concurrently displayed within the UI, receive an input for changing the first magnification to a second magnification higher than the reference magnification, and based on the input, display, via the display, within the first region, a second preview image of a second scene where a portion of the first scene is enlarged to the second magnification, and display, via the display, within the second region, a guidance image indicating the second scene with respect to at least portion of the first scene.

### CROSS-REFERENCE TO RELATED APPLICATION(S)

This application is a continuation application, claiming priority under § 365 (c), of an International application No. PCT/KR2023/007545, filed on Jun. 1, 2023, which is based on and claims the benefit of a Korean patent application number 10-2022-0087868, filed on Jul. 17, 2022, in the Korean Intellectual Property Office, and of a Korean patent application number 10-2022-0099030, filed on Aug. 9, 2022, in the Korean Intellectual Property Office, the disclosure of each of which is incorporated by reference herein in its entirety.

### BACKGROUND

### 1. Field

The disclosure relates to an electronic device, a method, and non-transitory computer readable storage medium for a user interface (UI) for photographing.

### 2. Description of Related Art

A portable electronic device may include a plurality of cameras. For example, the electronic device may display a user interface (UI) for photographing, for an image obtained through at least one of the plurality of cameras. For example, the UI may include a viewfinder region so that a photographer may check a state of the image.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and non-transitory computer readable storage medium for a user interface (UI) for photographing.

Additional aspects will be set forth in part in the description which follows and, in part, will be apparent from the description, or may be learned by practice of the presented embodiments.

In accordance with an aspect of the disclosure, an electronic device is provided. The electronic device includes a display, a plurality of cameras, memory storing one or more computer programs, and one or more processors including processing circuitry coupled to the display, the plurality of cameras, and the memory, wherein the one or more computer programs include computer-executable instructions that, when executed by the one or more processors individually or collectively, cause the electronic device to display, via the display, within a first region of a user interface (UI) for photographing, a first preview image of a first scene obtained through at least one of the plurality of cameras at a first magnification lower than a reference magnification, and display, via the display, within a second region of the UI different from the first region, one or more thumbnail images respectively indicating one or more images obtained through at least one of the plurality of cameras, while the first preview image and the one or more thumbnail images are concurrently displayed within the UI, receive an input for changing the first magnification to a second magnification higher than the reference magnification, and based on the input, display, via the display, within the first region, a second preview image of a second scene where a portion of the first scene is enlarged to the second magnification, and display, via the display, within the second region, a guidance image indicating the second scene with respect to at least portion of the first scene.

In accordance with another aspect of the disclosure, a method executed in an electronic device including a display and a plurality of cameras is provided. The method includes displaying, via the display, within a first region of a user interface (UI) for photographing, a first preview image, of a first scene obtained through at least one of the plurality of cameras at a first magnification lower than a reference magnification, and displaying, via the display, within a second region of the UI different from the first region, one or more thumbnail images respectively indicating one or more images obtained through at least one of the plurality of cameras, while the first preview image and the one or more thumbnail images are concurrently displayed within the UI, receiving an input for changing the first magnification to a second magnification higher than the reference magnification, and based on the input, displaying, via the display, within the first region, a second preview image of a second scene where a portion of the first scene is enlarged to the second magnification, and displaying, via the display, within the second region, a guidance image indicating the second scene with respect to at least portion of the first scene.

In accordance with another aspect of the disclosure, one or more non-transitory computer readable storage media storing computer-executable instructions that, when executed by one or more processors of an electronic device with a display and a plurality of cameras individually or collectively, cause the electronic device to perform operations are provided. The operations include displaying, via the display, within a first region of a user interface (UI) for photographing, a first preview image, of a first scene obtained through at least one of the plurality of cameras at a first magnification lower than a reference magnification, and displaying, via the display, within a second region of the UI different from the first region, one or more thumbnail images respectively indicating one or more images obtained through at least one of the plurality of cameras, while the first preview image and the one or more thumbnail images are concurrently displayed within the UI, receiving an input for changing the first magnification to a second magnification higher than or equal to the reference magnification, and based on the input, displaying, via the display, within the first region, a second preview image of a second scene where a portion of the first scene is enlarged to the second magnification, and displaying, via the display, within the second region, a guidance image indicating the second scene with respect to at least portion of the first scene.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an environment including an electronic device according to an embodiment of the disclosure;

FIG. 2 illustrates an electronic device capable of performing operations to be exemplified according to an embodiment of the disclosure;

FIG. 3 illustrates an operation of displaying a guidance image in a user interface (UI) for photographing according to an embodiment of the disclosure;

FIG. 4 illustrates a UI including a first region and a second region according to an embodiment of the disclosure;

FIG. 5 illustrates a guidance image moved according to movement of a visual object according to an embodiment of the disclosure;

FIG. 6 illustrates an operation of displaying a third preview image, in response to an input received while displaying a first preview image according to an embodiment of the disclosure;

FIG. 7 illustrates a third preview image displayed in response to an input received while a first preview image is displayed according to an embodiment of the disclosure;

FIG. 8 illustrates an operation of changing a display state of a second preview image in response to a user input on a guidance image according to an embodiment of the disclosure;

FIGS. 9, 10, 11, and 12 illustrate a display state of a second preview image changed in response to a user input on a guidance image according to various embodiments of the disclosure;

FIG. 13 illustrates an operation of displaying a first region having an enlarged size according to a change from a first state to a second state according to an embodiment of the disclosure;

FIG. 14 illustrates a plurality of states of an electronic device according to an embodiment of the disclosure;

FIG. 15 illustrates a UI changed in response to a change from a first state to a second state or a change from the second state to the first state according to an embodiment of the disclosure;

FIG. 16 illustrates a UI changed in response to a change from a first state to a second state or a change from the first state to a third state according to an embodiment of the disclosure; and

FIG. 17 illustrates an operation of identifying whether a first state is changed to a second state according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

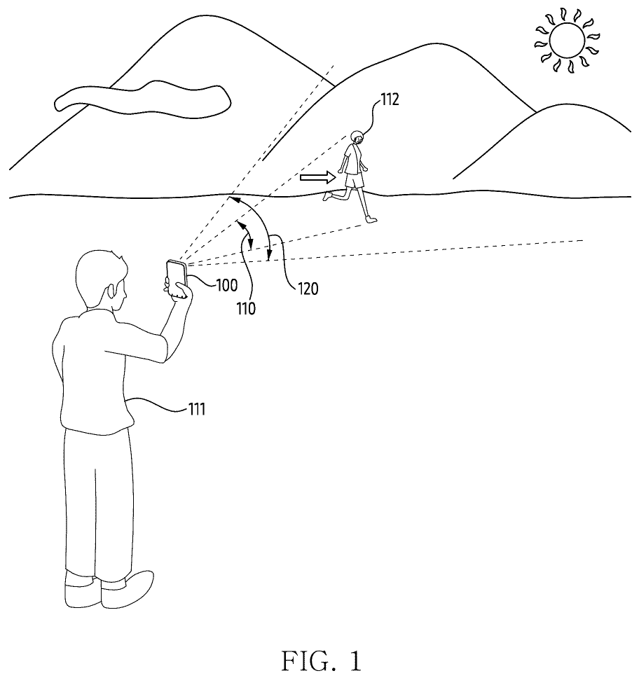

FIG. 1 illustrates an environment including an electronic device according to an embodiment of the disclosure.

Referring to FIG. 1, an electronic device 100 may include a telephoto camera and a wide angle camera. For example, a field of view (FOV) 110 of the telephoto camera may be relatively narrow. For example, when a user 111 uses the telephoto camera to photograph a moving subject 112 at a high magnification, the user 111 may feel inconvenience due to the FOV 110 of the telephoto camera, which is relatively narrow with respect to the high magnification, while tracking the movement of the subject 112. For example, in order to address the inconvenience, the electronic device 100 may display, within a user interface (UI) for photographing, a guidance image indicating a scene obtained through a telephoto camera with respect to a scene obtained through a wide-angle camera having an FOV 120 wider than the FOV 110. For example, as a size of the guidance image increases, the inconvenience may be further reduced.

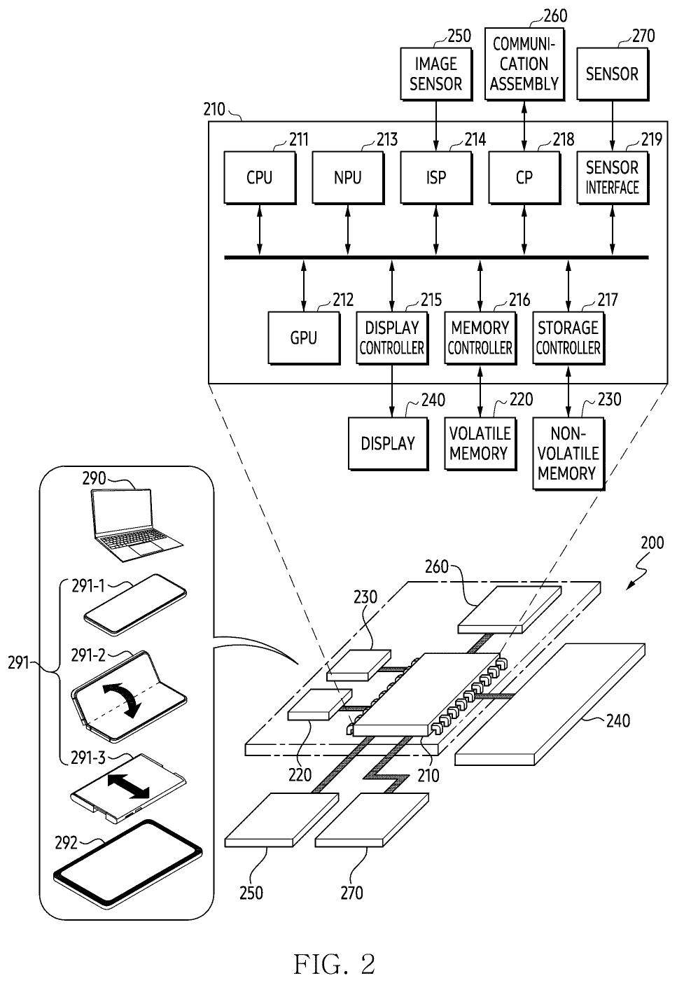

FIG. 2 illustrates an electronic device capable of performing operations to be exemplified according to an embodiment of the disclosure.

Referring to FIG. 2, an electronic device 200 (e.g., the electronic device 100) may be one of various types of mobile devices, such as a notebook 290, a smartphone 291 with various form factors (e.g., a bar-type smartphone 291-1, a foldable smartphone 291-2, or rollable smartphone 291-3), a tablet 292, a cellular phone, and other similar computing devices. Components, their relationships, and their functions shown in FIG. 2 are exemplary and do not limit implementations described or claimed in this document. The electronic device 200 may be referred to as a user device, a multifunctional device, or a portable device.

The electronic device 200 may include components including a processor 210, volatile memory 220, nonvolatile memory 230, a display 240, an image sensor 250, communication circuitry 260, and a sensor 270. The components are exemplary only. For example, the electronic device 200 may include other components (e.g., a power management integrated circuit (PMIC), audio processing circuitry, or an input/output interface). For example, some components may be omitted from the electronic device 200.

The processor 210 may be implemented with one or more integrated circuit (IC) chips and may execute various data processes. For example, the processor 210 may be implemented with a system on chip (SoC) (e.g., one chip or chipset). The processor 210 may include sub-components including a central processing unit 211, a graphics processing unit 212, a neural processing unit 213 (NPU), an image signal processor 214, a display controller 215, a memory controller 216, a storage controller 217, a communication processor 218, and/or a sensor interface 219. The sub-components are exemplary only. For example, the processor 210 may further include other sub-components. For example, some sub-components may be omitted from the processor 210.

The CPU 211 may be configured to control the sub-components, based on execution of instructions stored in the volatile memory 220 and/or the nonvolatile memory 230. The GPU 212 may include a circuit configured to execute parallel operations (e.g., rendering). The NPU 213 may include a circuit configured to execute operations for an artificial intelligence model (e.g., convolution computation).

The ISP 214 may include a circuit configured to process a raw image obtained through the image sensor 250 in a format suitable for a component in the electronic device 200 or a sub-component in the processor 210.

For example, the image sensor 250 may include a plurality of cameras. For example, the image sensor 250 may include a wide-angle camera and a telephoto camera. For example, the wide-angle camera may have a first FOV (e.g., the FOV 120) and a first focal length. For example, the wide-angle camera may be referred to as a first camera. For example, the telephoto camera may have a second FOV (e.g., the FOV 110) narrower than the first FOV and a second focal length longer than the first focal length. For example, the telephoto camera may be referred to as a second camera. For example, a direction toward which the first camera is directed may correspond to a direction toward which the second camera is directed.

The display controller 215 may include a circuit configured to process an image obtained from the CPU 211, the GPU 212, the ISP 214, or the volatile memory 220 in a format suitable for the display 240. The memory controller 216 may include a circuit configured to control reading data from the volatile memory 220 and writing data to the volatile memory 220. The storage controller 217 may include a circuit configured to control reading data from the nonvolatile memory 230 and writing data to the nonvolatile memory 230. The CP 218 may include a circuit configured to process data obtained from sub-components within the processor 210 in a format suitable for transmission to another electronic device via the communication circuitry 260, or process data obtained through the communication circuitry 260 from another electronic device in a format suitable for processing the sub-components. The sensor interface 219 may include a circuit configured to process data about a state of the electronic device 200 and/or a state around the electronic device 200, obtained through the sensor 270, in a suitable format for sub-components within the processor 210.

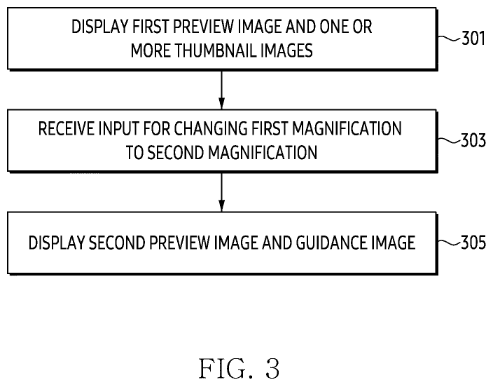

FIG. 3 illustrates an operation of displaying a guidance image in a user interface (UI) for photographing according to an embodiment of the disclosure.

Operations illustrated through FIG. 3 may be executed by the electronic device 100 illustrated in FIG. 1, the electronic device 200 illustrated in FIG. 2, or the processor 210 of the electronic device 200 illustrated in FIG. 2.

Referring to FIG. 3, in operation 301, the processor 210 may display, via the display 240, a first preview image, representing a first scene, obtained through at least one of a plurality of cameras (e.g., the image sensor 250 of FIG. 2) of the electronic device 200, and one or more thumbnail images respectively indicating one or more images obtained through at least one of the plurality of cameras. For example, the first preview image and the one or more thumbnail images may be displayed in a user interface (UI) for photographing.

For example, the first preview image may be displayed within a first region of the UI. For example, the first region may include a viewfinder region. For example, the first region may include an executable object for controlling an image (e.g., a static image and a dynamic image (e.g., video)) corresponding to the first preview image. For example, when the image is a static image, the first region may include an executable object indicating to obtain the image (e.g., a visual shooting button). For example, when the image is a dynamic image, the first region may include an executable object for initiating obtaining of the image and terminating obtaining of the image. However, it is not limited thereto.

For example, the first preview image may represent the first scene. For example, the first scene may represent at least a portion of the environment, around the electronic device 200, included in at least one FOV of the plurality of cameras. For example, the first preview image may be displayed at a first magnification, which is less than a reference magnification. For example, the reference magnification will be exemplified in operation 303.

For example, the one or more thumbnail images may be displayed within a second region of the UI. For example, the second region may include a region displaying the one or more thumbnail images corresponding to the one or more images, which are obtained or were obtained while displaying the first preview image. For example, the second region may include a region displaying the one or more thumbnail images corresponding to the one or more images, which were obtained before displaying the first preview image. For example, the second region may be a region provided to call or display, within the UI, N images (N is a natural number of 1 or more) recently obtained using the electronic device 200 (or at least one of the plurality of cameras). For example, the number (e.g., N) of the one or more thumbnail images, which may be displayed within the second region, may be predefined or predetermined based on a size of the second region. However, it is not limited thereto. For example, the second region may be referred to as a capture and view region.

For example, a size of each of the one or more thumbnail images may be larger than a size of an item (e.g., a circular item positioned around the visual shooting button) within the first region representing the most recently obtained single image. For example, since the size of each of the one or more thumbnail images is larger than the size of the item, each of the one or more thumbnail images may provide more detailed information than the item. However, it is not limited thereto.

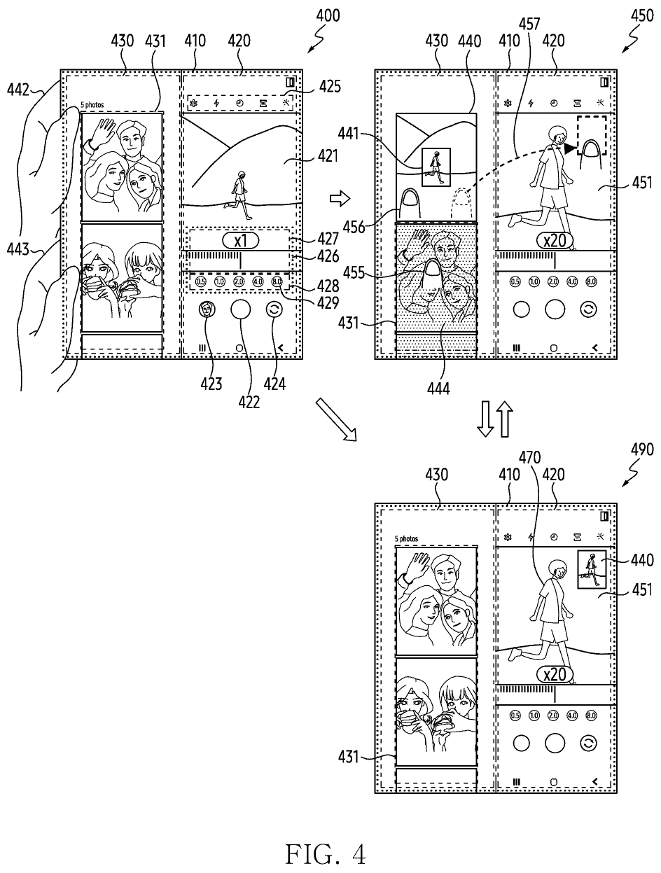

The UI including the first region and the second region may be exemplified through FIG. 4.

FIG. 4 illustrates a UI including a first region and a second region according to an embodiment of the disclosure.

Referring to FIG. 4, in state 400, a processor 210 may display a UI 410, which is the UI. For example, the UI 410 may include a first region 420 and a second region 430.

For example, the first region 420 may include a first preview image 421, which is the first preview image. For example, the first region 420 may include an executable object 422 that is a photographing button. For example, the first region 420 may include an executable object 423 that is the item. For example, the executable object 423 may be used to display a UI of a software application for managing a photo (or image), in response to a touch input. For example, the processor 210 may display the UI of the software application including the most recently taken picture, in response to the touch input on the executable object 423. For example, the first region 420 may include an executable object 424 for changing a camera used to obtain an image. For example, the first region 420 may include executable objects 425 to provide effects and settings to be applied to an image, which is being obtained through the camera or will be obtained through the camera. For example, the first region 420 may include a set 426 of executable objects for changing a magnification of the first preview image 421 and/or a magnification of an image corresponding to the first preview image 421. For example, an executable object 427 in the set 426 may be used to change the magnification (and/or the magnification of the image) of the first preview image 421 at a magnification indicated by a drag input. For example, executable objects 428 in the set 426 may be used to change the magnification (and/or the magnification of the image) of the first preview image 421 at a magnification indicated by one executable object, identified by a touch input from among the executable objects 428. However, it is not limited thereto.

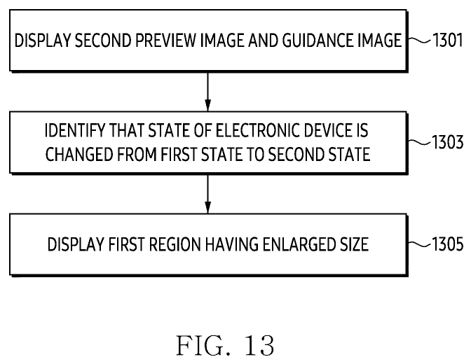

For example, the first region 420 may be a region maintained in the UI 410 independently of a change in a state of the electronic device 200. The change in the state of the electronic device 200 will be exemplified through a description of FIGS. 13 to 17.

For example, the second region 430 may include one or more thumbnail images 431, which are the one or more thumbnail images. For example, the one or more thumbnail images 431 may indicate the one or more images, which are recently obtained through the electronic device 200 or a camera of the electronic device 200. For example, a size of each of the one or more thumbnail images 431 may be larger than a size of the executable object 423. However, it is not limited thereto.

Referring back to FIG. 3, in operation 303, the processor 210 may receive an input for changing the first magnification to a second magnification greater than or equal to the reference magnification, while the first preview image and the one or more thumbnail images are displayed within the UI. For example, the reference magnification may be a parameter for identifying whether to display a guidance image, which will be exemplified below, within the second region. For example, the reference magnification may be a parameter used to identify whether to execute operation 305. For example, the reference magnification may be 20 times. However, it is not limited thereto.

In operation 305, the processor 210 may display, via the display 240, a second preview image within the first region and display a guidance image within the second region, based on the input. For example, the second preview image may represent a second scene in which a portion of the first scene is enlarged at the second magnification. According to an embodiment of the disclosure, a camera used to obtain the second preview image may be different from a camera used to obtain the first preview image. For example, the first preview image may be obtained through the first camera exemplified in FIG. 2, and the second preview image may be obtained through the second camera exemplified in FIG. 2. According to an embodiment of the disclosure, a camera used to obtain the second preview image may be the same as a camera used to obtain the first preview image. For example, the second preview image may be an image in which the first preview image is enlarged through digital zoom. However, it is not limited thereto.

For example, the guidance image may be an image for guiding or assisting photographing through the second preview image. For example, the guidance image may indicate the second scene with respect to at least a portion of the first scene. For example, the guidance image may include a visual element for notifying or guiding a position of the second scene within the at least portion of the first scene. According to an embodiment of the disclosure, the guidance image may indicate the second scene with respect to the first scene. For example, the guidance image may indicate the second scene indicated by the second preview image displayed at the second magnification, with respect to the first scene indicated by the first preview image displayed at the first magnification. According to an embodiment of the disclosure, the guidance image may indicate the second scene with respect to a portion of the first scene. For example, the guidance image may indicate the second scene indicated by the second preview image displayed at the second magnification with respect to the portion of the first scene indicated by a portion of the first preview image displayed at a third magnification, the third magnification greater than the first magnification and less than the second magnification. According to an embodiment of the disclosure, the third magnification may be less than the reference magnification. According to an embodiment of the disclosure, the third magnification may be greater than or equal to the reference magnification. However, it is not limited thereto. According to an embodiment of the disclosure, the third magnification may be identified based on the second magnification. For example, the third magnification may be 1/a times the second magnification (a is a real number greater than or equal to 1). For example, when a is 5 and the second magnification is 20, the third magnification may be 4. For example, when a is 5 and the second magnification is 50, the third magnification may be 10. For example, when a is 5 and the second magnification is 100, the third magnification may be 20. For example, when a is 10 and the second magnification is 100, the third magnification may be 10. However, it is not limited thereto.

According to an embodiment of the disclosure, the guidance image may indicate the second preview image with respect to an image having a fourth magnification less than the first magnification. For example, the image may be an image representing a scene including the first scene. However, it is not limited thereto.

For example, the guidance image may be referred to as a map view image or a mini-map image.

According to an embodiment of the disclosure, the first preview image, the second preview image, and the guidance image may be displayed while a video is obtained through at least one of the plurality of cameras. However, it is not limited thereto.

The second preview image and the guidance image may be exemplified through FIG. 4.

Referring to FIG. 4, in state 400, the processor 210 may receive the input. For example, the input may be an input for changing the first magnification to a second magnification greater than or equal to the reference magnification. For example, the input may be an input for enlarging the first preview image 421. For example, the input may be received through an executable object 427. For example, the input may be a drag input received through the executable object 427. For example, the second magnification may be identified based on a position at which the drag input is released. For example, the input may be a tap input indicating to select an executable object (e.g., an executable object 429) from among executable objects 428. For example, the second magnification may be a magnification (e.g., 8 times) indicated by the executable object (e.g., the executable object 429). For example, the processor 210 may change the state 400 to a state 450 in response to the input. For example, the processor 210 may change the state 400 to the state 450 based on the second magnification greater than or equal to the reference magnification.

In the state 450, the processor 210 may display, within the first region 420, a second preview image 451 that is the second preview image. For example, the processor 210 may display, within the second region 430, the guidance image 440 that is the guidance image. For example, the guidance image 440 may include a visual element 441. For example, the visual element 441 may indicate the second scene with respect to at least a portion of the first scene. For example, the visual element 441 may be included in the guidance image 440, in order to inform a position of the second scene within the at least portion of the first scene. According to an embodiment of the disclosure, the visual element 441, which is an element independent of the guidance image 440, may be an element superimposed on the guidance image 440. However, it is not limited thereto.

According to an embodiment of the disclosure, like the state 450, based on the input, the processor 210 may cease displaying a portion of the one or more thumbnail images 431 within the second region 430, and display the guidance image 440 within the second region 430. For example, the one or more thumbnail images 431 may be moved based on the input. For example, displaying the portion of the one or more thumbnail images 431 may be ceased according to the movement. According to an embodiment of the disclosure, unlike the illustration of the state 450, the processor 210 may display, within the second region 430, a guidance image 440 replacing one of the one or more thumbnail images 431 based on the input. According to an embodiment of the disclosure, unlike the illustration of the state 450, the processor 210 may display, within the second region 430, the guidance image 440 and the one or more thumbnail images 431 having a reduced size, based on the input. However, it is not limited thereto.

According to an embodiment of the disclosure, the guidance image 440 may be visually highlighted relative to a remaining portion of the one or more thumbnail images 431 in which the display is maintained within the second region 430 after the input is received. According to an embodiment of the disclosure, the remaining portion of the one or more thumbnail images 431, maintained in the second region 430 after the input is received, may be blurred, unlike the guidance image 440. According to an embodiment of the disclosure, the remaining portion of the one or more thumbnail images 431, maintained in the second region 430 after the input is received, may be dimmed, unlike the guidance image 440. For example, the processor 210 may display a semi-transparent layer superimposed on the remaining portion of the one or more thumbnail images 431. However, it is not limited thereto.

According to an embodiment of the disclosure, a position of the guidance image 440 within the second region 430 may be identified based on a grip state of the electronic device 200. For example, when the electronic device 200 is gripped within the state 400, such as a grip state 442, the guidance image 440 may be displayed at a position illustrated in the state 450, which is a position corresponding to the grip state 442. For example, when the electronic device 200 is gripped within the state 400, such as a grip state 443, the guidance image 440 may be displayed at a position corresponding to the grip state 443, unlike the illustration of the state 450. For example, the guidance image 440 may be displayed at a position where a thumbnail image 444, which is one of the one or more thumbnail images 431, is displayed, which is a position corresponding to the grip state 443, unlike the state 450. However, it is not limited thereto.

According to an embodiment of the disclosure, in the state 450, the processor 210 may receive a user input 455 indicating to select the remaining portion of the one or more thumbnail images 431 from among the guidance image 440 and the remaining portion of the one or more thumbnail images 431. For example, the processor 210 may change the state 450 to a state 490, in response to the input 455.

According to an embodiment of the disclosure, in the state 450, the processor 210 may receive a user input 456 indicating to select the guidance image 440 from among the guidance image 440 and the remaining portion of the one or more thumbnail images 431. For example, the processor 210 may change the state 450 to the state 490, in response to the input 456.

According to an embodiment of the disclosure, in the state 450, the processor 210 may receive a user input 457 indicating to move the guidance image 440 to the first region 420. For example, the processor 210 may change the state 450 to the state 490 in response to the input 457. For example, the guidance image 440 moved to the first region 420 through the user input 457 may be displayed at a position within the first region 420 where the user input 457 is released. However, it is not limited thereto.

In the state 490, the processor 210 may cease displaying the guidance image 440 within the second region 430. For example, the processor 210 may cease displaying the guidance image 440 within the second region 430 and display the guidance image 440 partially superimposed on the second preview image 451 displayed within the first region 420. For example, a size of the guidance image 440 superimposed on the second preview image 451 (e.g., the guidance image 440 in the state 490) may be smaller than a size of the guidance image 440 displayed within the second region 430 (e.g., the guidance image 440 in the state 450). For example, in response to a user input (e.g., the user input 455, the user input 456, and/or the user input 457) to change the state 450 to the state 490, the processor 210 may resume displaying the portion of the one or more thumbnail images 431 within the second region 430.

According to an embodiment of the disclosure, the state 490 may be defined as an intermediate state between the state 400 and the state 450. For example, in the state 400, the processor 210 may receive an input for changing the first magnification to a third magnification that is greater than the first magnification and less than the reference magnification. The processor 210 may change the state 400 to the state 490, in response to the input. For example, the processor 210 may change the state 400 to the state 490, based on identifying that the third magnification indicated by the input received in the state 400 is less than the reference magnification. In the state 490 changed from the state 400, the processor 210 may maintain a display state of the second region 430. In the state 490 changed from the state 400, the processor 210 may display a guidance image superimposed on a third preview image. For example, the third preview image may indicate a third scene representing a third scene in which a portion of the first scene is enlarged at the third magnification. For example, the guidance image may indicate the third scene with respect to the at least a portion of the first scene. For example, in the state 490, the processor 210 may receive an input for changing the third magnification to the second magnification while the guidance image and the third preview image are displayed. For example, the processor 210 may change the state 490 to the state 450 in response to the input. According to an embodiment of the disclosure, the processor 210 may identify, in response to the input, that the input is an input to change a size of a visual object corresponding to a focused subject within the first scene and/or the third scene to be greater than or equal to a reference size, and change the state 490 to the state 450, in response to the identification.

According to an embodiment of the disclosure, the processor 210 may change the state 490 to the state 450, in response to a user input indicating to move the guidance image 440 displayed in the state 490 to the second region 430.

According to an embodiment of the disclosure, the guidance image 440 displayed in the state 490 may be superimposed on a second portion of a second preview image 451, distinct from a first portion of the second preview image 451, including a visual object 470 corresponding to a subject focused within the second scene (or the third scene). For example, the guidance image 440 may be displayed at a position that does not cover the visual object 470, such as the illustration in the state 490. However, it is not limited thereto.

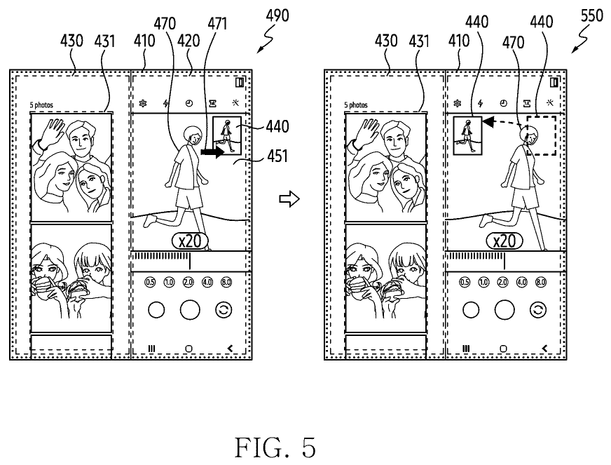

According to an embodiment of the disclosure, the guidance image 440 displayed in the state 490 may be moved. The movement of the guidance image 440 may be exemplified through FIG. 5.

FIG. 5 illustrates a guidance image moved according to movement of a visual object according to an embodiment of the disclosure.

Referring to FIG. 5, the processor 210 may identify a visual object 470 moved to the second portion of the second preview image 451 in the state 490. For example, the processor 210 may change the state 490 to a state 550, in response to the movement 471 of the visual object 470. For example, in the state 550, the processor 210 may display a guidance image 440 superimposed on the first portion of the second preview image 451 or the third portion of the second preview image. For example, the guidance image 440 may avoid the visual object 470 so as not to be superimposed on the visual object 470. However, it is not limited thereto.

As described above, the electronic device 200 may display the guidance image within the second region, in response to an input for changing the first magnification to the second magnification. For example, a size of the guidance image displayed within the second region may be larger than a size of the guidance image displayed within the first region. For example, the electronic device 200 may provide an enhanced photographing environment by displaying the guidance image within the second region. For example, a user of the electronic device 200 may more easily recognize a direction toward which the second camera providing a relatively high magnification is directed.

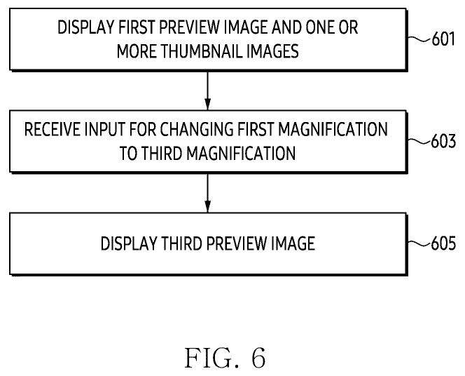

FIG. 6 illustrates an operation of displaying a third preview image, in response to an input received while displaying a first preview image according to an embodiment of the disclosure.

The operations exemplified through FIG. 6 may be executed by the electronic device 100 illustrated in FIG. 1, the electronic device 200 illustrated in FIG. 2, or the processor 210 of the electronic device 200 illustrated in FIG. 2.

Referring to FIG. 6, in operation 601, the processor 210 may display the first preview image within the first region and display the one or more thumbnail images within the second region. For example, the first preview image may represent the first scene at the first magnification. For example, operation 601 may correspond to operation 301 of FIG. 3.

In operation 603, the processor 210 may receive an input for changing the first magnification to a third magnification that is greater than the first magnification and less than the reference magnification. For example, the input received in operation 603 may be received while the first preview image is displayed within the first region and the one or more thumbnail images are displayed within the second region.

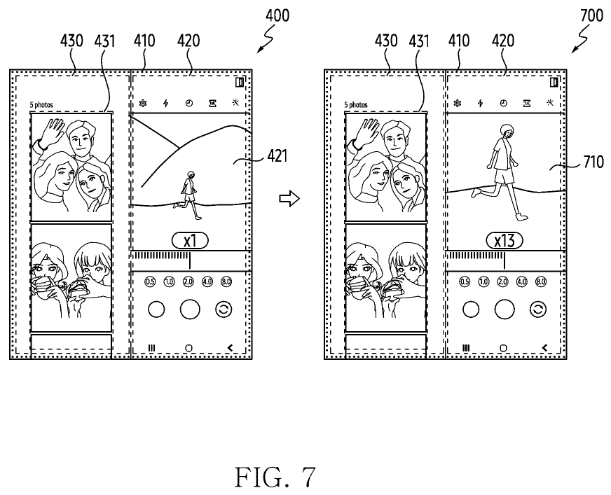

In operation 605, the processor 210 may display, within the first region, a third preview image representing a third scene in which a portion of the first scene is enlarged at the third magnification, in response to the input received in operation 603. For example, the processor 210 may maintain a display state of the second region, in response to the input received in operation 603. For example, the processor 210 may refrain from or bypass displaying the guidance image within the second region, based on the third magnification less than the reference magnification. The maintenance of a state of displaying the third preview image and displaying the second region may be exemplified through FIG. 7.

FIG. 7 illustrates a third preview image displayed in response to an input received while a first preview image is displayed according to an embodiment of the disclosure.

Referring to FIG. 7, in the state 400, the processor 210 may receive an input for changing the first magnification to the third magnification. The processor 210 may change the state 400 to a state 700, in response to the input.

In the state 700, the processor 210 may display, within the first region 420, a third preview image 710, which is the third preview image. For example, the third preview image 710 may represent the third scene in which a portion of the first scene is enlarged at the third magnification. The processor 210 may maintain a display state of the second region 430 independently of the input (or regardless of the input). For example, the processor 210 may maintain displaying the one or more thumbnail images 431, within the second region 430. For example, the processor 210 may refrain from displaying the guidance image 440 within the second region 430, as shown in the state 450 of FIG. 4.

As described above, the electronic device 200 may refrain from displaying the guidance image (e.g., the guidance image 440) within the second region, in response to an input for changing the first magnification to the third magnification. For example, unlike the second magnification, the third magnification may be a magnification capable of easily recognizing a direction toward which the second camera is directed. For example, when the first magnification is changed to the third magnification, the electronic device 200 may provide an enhanced photographing environment by displaying the third preview image and refraining from displaying the guidance image.

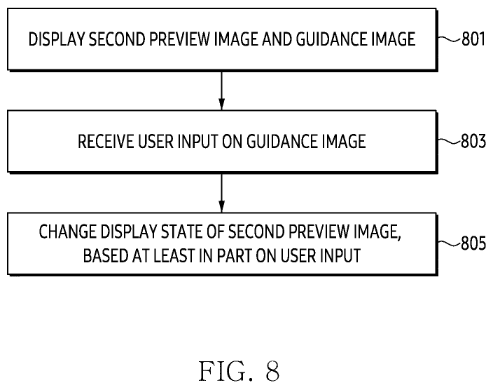

FIG. 8 illustrates an operation of changing a display state of a second preview image in response to a user input on a guidance image according to an embodiment of the disclosure.

The operations exemplified through FIG. 8 may be executed by the electronic device 100 illustrated in FIG. 1, the electronic device 200 illustrated in FIG. 2, or the processor 210 of the electronic device 200 illustrated in FIG. 2.

Referring to FIG. 8, in operation 801, the processor 210 may display the second preview image within the first region and display the guidance image within the second region. For example, operation 801 may correspond to operation 305 of FIG. 3.

In operation 803, the processor 210 may receive a user input on the guidance image while the second preview image is displayed within the first region and the guidance image is displayed within the second region. For example, the user input may be received to change a display state of the second preview image. For example, the user input may be received for a setting or effect to be applied to an image obtained or to be obtained through the second preview image. For example, the user input may be a touch input having a contact point on the guidance image. However, it is not limited thereto.

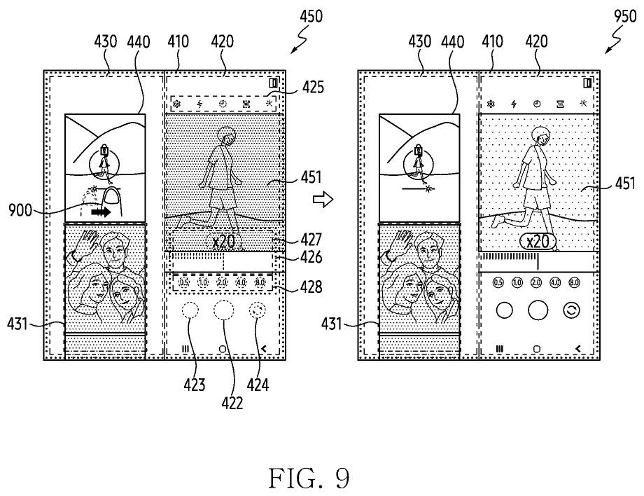

In operation 805, the processor 210 may change a display state of the second preview image, based at least in part on the user input. For example, the processor 210 may change a state of the guidance image, based at least in part on the user input. The change in the display state of the second preview image may be exemplified through FIGS. 9, 10, 11, and 12.

FIGS. 9, 10, 11, and 12 illustrate a display state of a second preview image changed in response to a user input on a guidance image according to various embodiments of the disclosure.

Referring to FIG. 9, in the state 450, the processor 210 may display a UI 410 that includes a first region 420 including a second preview image 451, and a second region 430 including a guidance image 440 and a remaining portion of one or more thumbnail images 431. For example, the processor 210 may receive a user input 900 for changing brightness of the second preview image 451. For example, the user input 900 may be an input that is released after a contact point on the guidance image 440 is moved. For example, the processor 210 may change the state 450 to a state 950, in response to the user input 900.

In the state 950, the processor 210 may change the display state of the second preview image 451 by changing the brightness of the second preview image 451 based at least in part on the user input 900. For example, the processor 210 may identify brightness corresponding to a moving distance of the user input 900 or a position where the user input 900 is released. The processor 210 may change the brightness of the second preview image 451 to the identified brightness. For example, the second preview image 451 in the state 950 may be brighter than the second preview image 451 in the state 450.

According to an embodiment of the disclosure, when the state 400 is changed to the state 450, at least a portion of a plurality of executable objects (e.g., executable objects 422 to 428) included within the first region 420 in the state 400 may be excluded from the first region 420 in the state 450. For example, when the second preview image 451 may be controlled through a user input for the guidance image 440, such as the user input 900, the at least a portion of the plurality of executable objects providing a function corresponding to the user input may not be displayed in the state 450. For example, the processor 210 may cease displaying the at least a portion of the plurality of executable objects in the first region 420 for changing the display state of the second preview image 451 within the state 450. However, it is not limited thereto.

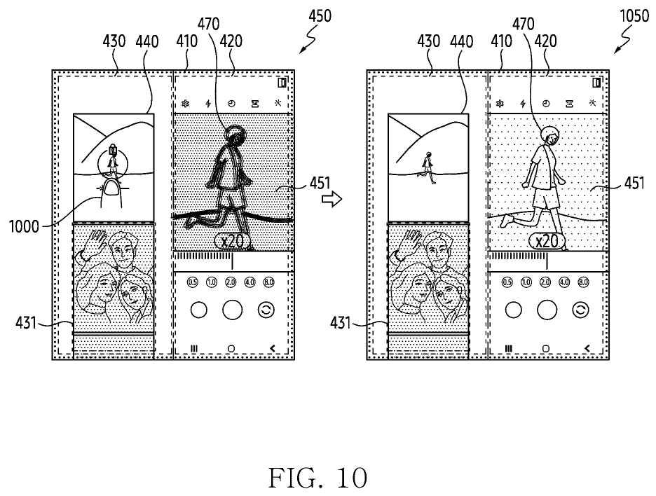

Referring to FIG. 10, in the state 450, the processor 210 may display a UI 410 that includes a first region 420 including the second preview image 451, and a second region 430 including the remaining portion from among the guidance image 440 and the one or more thumbnail images 431. For example, the processor 210 may receive a user input 1000 to control an auto exposure (AE) function and/or an auto focus (AF) function of a camera (e.g., the second camera) related to the second preview image 451. For example, the user input 1000 may be an input having a contact point on the guidance image 440. For example, the processor 210 may change the state 950 to a state 1050, in response to the user input 1000.

In the state 1050, the processor 210 may change the display state of the second preview image 451, by controlling the AE function and/or the AF function based at least in part on the user input. For example, the processor 210 may change the display state of the second preview image 451, by changing an exposure state of the second camera based on a position on the guidance image 440 in which the user input is received. For example, the processor 210 may change the display state of the second preview image 451, by changing a focus state of the second camera based on the position. For example, the second preview image 451 in the state 1050 may have a display state identified based on a visual object 470 corresponding to the position, unlike the second preview image 451 in the state 450.

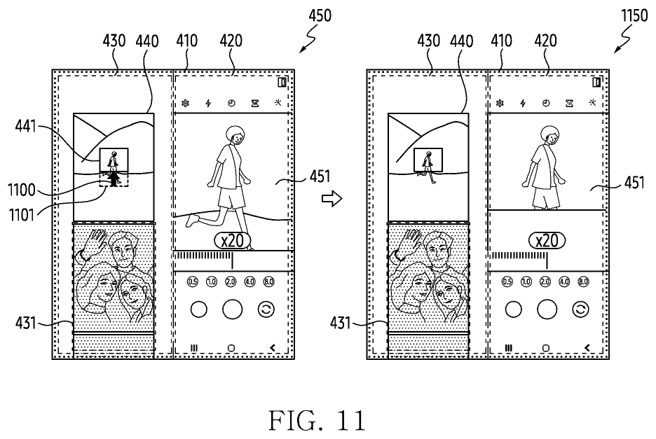

Referring to FIG. 11, in the state 450, the processor 210 may display a UI 410 that includes a first region 420 including the second preview image 451 and a second region 430 including the remaining portion from among the guidance image 440 and the one or more thumbnail images 431. For example, the processor 210 may receive a user input 1100 for changing an aspect ratio of the second preview image 451. For example, the user input 1100 may be an input for changing a size of a visual element 441 in the guidance image 440. For example, the user input 1100 may be an input indicating to move an edge 1101 of the visual element 441. For example, the processor 210 may change the state 450 to a state 1150 in response to the user input 1100.

In the state 1150, the processor 210 may change the display state of the second preview image 451, by changing an aspect ratio of the second preview image 451 based at least in part on the user input 1100. For example, the processor 210 may identify a position where the user input 1100 is released. For example, the processor 210 may identify an aspect ratio of the second preview image 451 based on the position. According to an embodiment of the disclosure, the processor 210 may identify a candidate aspect ratio corresponding to the position among a plurality of predefined candidate aspect ratios in the electronic device 200, and change the aspect ratio of the second preview image 451 to the identified candidate aspect ratio. For example, the plurality of candidate aspect ratios may include 3:4, 9:16, and 1:1. However, it is not limited thereto. For example, the second preview image 451 in the state 1150 may have an aspect ratio different from that of the second preview image 451 in the state 450. For example, the arrangement of the plurality of executable objects in the first region 420 may be changed according to the changed aspect ratio of the second preview image 451. However, it is not limited thereto.

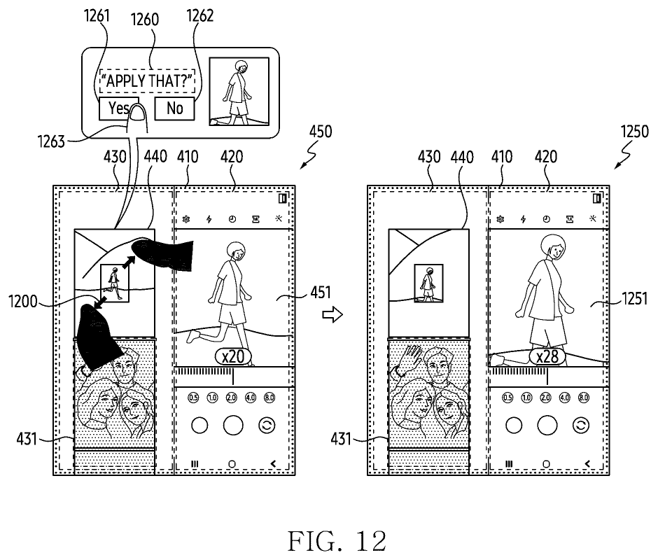

Referring to FIG. 12, in the state 450, the processor 210 may display a UI 410 that includes a first region 420 including the second preview image 451 and a second region 430 including the remaining portion from among the guidance image 440 and the one or more thumbnail images 431. For example, the processor 210 may receive a user input 1200 for changing the second magnification to a third magnification greater than the second magnification. For example, the user input 1200 may be an input in which two contact points move away from each other to enlarge a portion of the guidance image 440. For example, the processor 210 may change the state 450 to a state 1250, in response to the user input 1200.

In the state 1250, the processor 210 may display, within the first region 420, a third preview image 1251 changed from the second preview image 451, based at least in part on the user input 1200. For example, the third preview image 1251 may represent a third scene in which a portion of the first scene is enlarged at the third magnification. For example, the processor 210 may identify the third magnification, based on a distance between the two contact points, a moving distance of the two contact points, and/or a position of the two contact points when the user input 1200 is released. The processor 210 may display the third preview image 1251 representing the third scene enlarged at the identified third magnification.

According to an embodiment of the disclosure, the processor 210 may display a message 1260 before changing the state 1250 from the state 450, in response to the user input 1200. For example, in response to the user input 1200, the processor 210 may display a guidance image indicating the third scene with respect to the at least a portion of the first scene and display the message 1260. For example, the message 1260 may include text indicating whether to replace the second preview image 451 with the third preview image 1251. For example, the message 1260 may include an executable object 1261 and an executable object 1262. The processor 210 may provide a state 1250, in response to receiving an input 1263 indicating to select the executable object 1261 from among the executable object 1261 and the executable object 1262. However, it is not limited thereto.

As described above, the electronic device 200 may change the display state of the second preview image through the guidance image within the second region. For example, since the guidance image within the second region represents the first scene wider than the second preview image, the change in the display state of the second preview image through the guidance image in the second region may provide a user experience of changing the display state of the second preview image based on a state of the first scene and a state of the second scene. For example, the electronic device 200 may provide an enhanced photographing environment.

FIG. 13 illustrates an operation of displaying a first region having an enlarged size according to a change from a first state to a second state according to an embodiment of the disclosure. The operations exemplified through FIG. 13 may be executed by the electronic device 100 illustrated in FIG. 1, the electronic device 200 illustrated in FIG. 2, or the processor 210 of the electronic device 200 illustrated in FIG. 2.

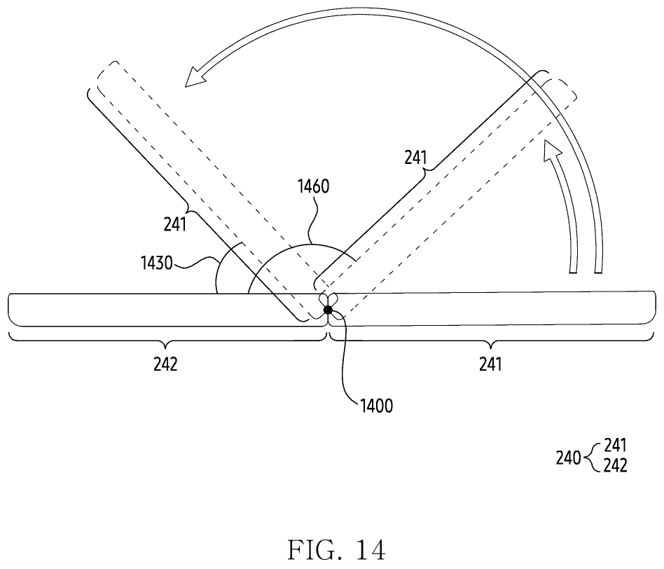

Referring to FIG. 13, in operation 1301, the processor 210 may display the second preview image within the first region and display the guidance image within the second region. For example, the processor 210 may display the second preview image within the first region and the guidance image within the second region, while the electronic device 200 is in a first state. For example, the first state may be one of a plurality of states of the electronic device 200. The plurality of states may be exemplified through FIG. 14.

FIG. 14 illustrates a plurality of states of an electronic device according to an embodiment of the disclosure.

Referring to FIG. 14, a display 240 of an electronic device 200 may be foldable with respect to an axis 1400. For example, the electronic device 200 may be in a plurality of states through the display 240 that is foldable based on the axis 1400.

For example, the display 240 may include a first display region 241 and a second display region 242 adjacent to the first display region 241. For example, since the display 240 is foldable based on the axis 1400, an angle between a first display region 241 and a second display region 242 (or an angle between a first direction toward which the first display region 241 faces and a second direction toward which the second display region 242 faces) may be changed. The electronic device 200 may have a plurality of states according to the angle. For example, a reference range may be predefined in the electronic device 200 to identify the plurality of states. For example, the reference range may include a first reference range for identifying the angle between 0 and an angle 1430 and a second reference range for identifying the angle between the angle 1430 and an angle 1460. For example, the first state of the plurality of states may be a state in which the angle is within the first reference range. For example, the second state of the plurality of states may be a state in which the angle is outside the first reference range and the second reference range. For example, a third state of the plurality of states may be a state in which the angle is within the second reference range. For example, the third state of the plurality of states may be a state in which the angle is within the second reference range and a portrait mode is provided. For example, the third state of the plurality of states may be a state in which the angle is within the second reference range and a landscape mode is provided. However, it is not limited thereto.

Referring back to FIG. 13, in operation 1303, the processor 210 may identify that a state of the electronic device 200 is changed from the first state illustrated through FIG. 14 to the second state illustrated through FIG. 14, while the second preview image is displayed within the first region and the guidance image is displayed within the second region.

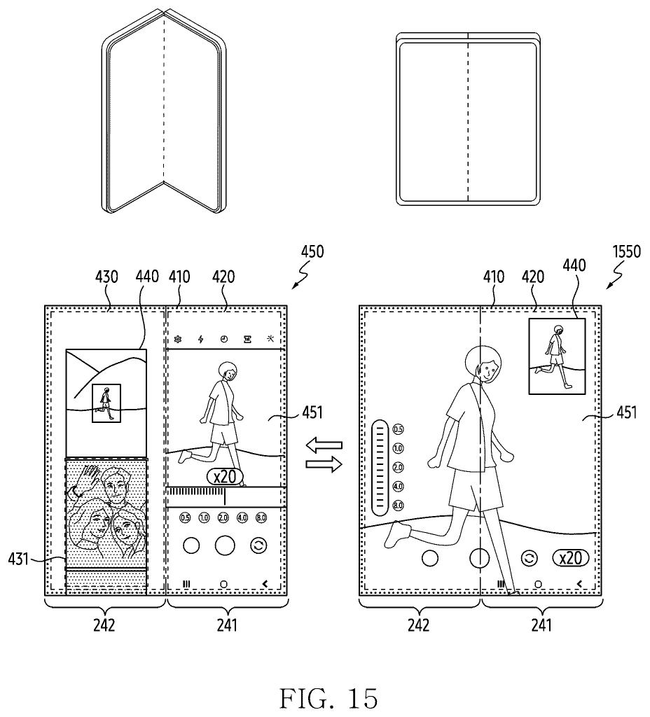

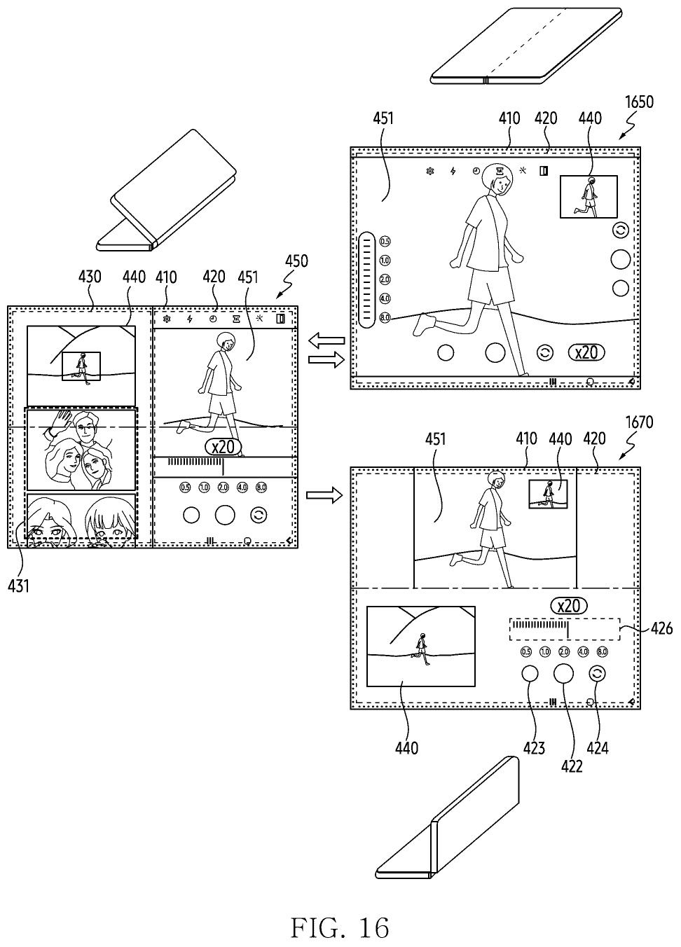

In operation 1305, in response to the identification, the processor 210 may cease displaying the second region, and display the first region having an enlarged size, including the second preview image having an enlarged size and the guidance image superimposed on the second preview image within a first display region (e.g., the first display region 241 of FIG. 14) of the display 240 and a second display region (e.g., the second display region 242 of FIG. 14) of the display 240. The first region having the enlarged size may be exemplified through FIGS. 15 and 16.

FIG. 15 illustrates a UI changed in response to a change from a first state to a second state or a change from the second state to the first state according to an embodiment of the disclosure.

FIG. 16 illustrates a UI changed in response to a change from a first state to a second state or a change from the first state to a third state according to an embodiment of the disclosure.

Referring to FIG. 15, the processor 210 may display a UI 410 that includes a first region 420 including the second preview image 451 and a second region 430 including the remaining portion from among the guidance image 440 and the one or more thumbnail images 431, as shown in the state 450, while the electronic device 200 providing the portrait mode is in the first state. For example, the processor 210 may identify a change from the first state to the second state. For example, the identification may be executed through an acceleration sensor, a gyro sensor, and/or a hall sensor in the electronic device 200. For example, the processor 210 may change the state 450 to a state 1550, in response to the identification.

In the state 1550, the UI 410 may include the first region 420 among the first region 420 and the second region 430. For example, the first region 420 may have an enlarged size than the first region 420 in the state 450. For example, the first region 420 may be displayed within the first display region 241 and the second display region 242. For example, the first region 420 may include the second preview image 451 having an enlarged size than the second preview image 451 in the state 450. For example, the display of the second region 430 may be ceased within the state 1550. For example, the guidance image 440 may be partially superimposed on the second preview image 451 having the enlarged size, according to the cessation of the display of the second region 430. According to an embodiment of the disclosure, a size of the guidance image 440 in the state 1550 may be larger than a size of the guidance image 440 in the state 490. However, it is not limited thereto.

In the state 1550, the processor 210 may identify that the state of the electronic device 200 is changed from the second state to the first state. The processor 210 may change the state 1550 to the state 450, in response to the identification. For example, according to the change from the state 1550 to the state 450, the guidance image 440 may be moved to the second region 430.

Referring to FIG. 16, the processor 210 may display a UI 410 that includes a first region 420 including the second preview image 451 and a second region 430 including the remaining portion from among the guidance image 440 and the one or more thumbnail images 431, as shown in the state 450, while the electronic device 200 providing the landscape mode is in the first state. For example, the processor 210 may identify a change from the first state to the second state. For example, the processor 210 may change the state 450 to a state 1650, in response to the identification.

In the state 1650, the UI 410 may include the first region 420 of the first region 420 and the second region 430. For example, the first region 420 may have an enlarged size than the first region 420 in the state 450. For example, the first region 420 may be displayed in the first display region 241 and the second display region 242. For example, the first region 420 may include a second preview image 451 having an enlarged size than the second preview image 451 in the state 450. For example, the display of the second region 430 may be ceased within the state 1650. For example, the guidance image 440 may be partially superimposed on the second preview image 451 having the enlarged size, according to the cessation of the display of the second region 430. According to an embodiment of the disclosure, a size of the guidance image 440 in the state 1650 may be larger than a size of the guidance image 440 in the state 490. However, it is not limited thereto.

In the state 1650, the processor 210 may identify that the state of the electronic device 200 is changed from the second state to the first state. The processor 210 may change the state 1650 to the state 450 in response to the identification. For example, the guidance image 440 may be moved to the second region 430 displayed according to the change from the state 1650 to the state 450.

As described above, the electronic device 200 may change the configuration of the UI according to whether the state of the electronic device 200 is the first state or the second state. For example, the electronic device 200 may provide a photographing environment that is adaptively changed according to the state of the electronic device 200, by displaying the guidance image within the second region while the electronic device 200 is in the first state and displaying the guidance image within the first region while the electronic device 200 is in the second state.

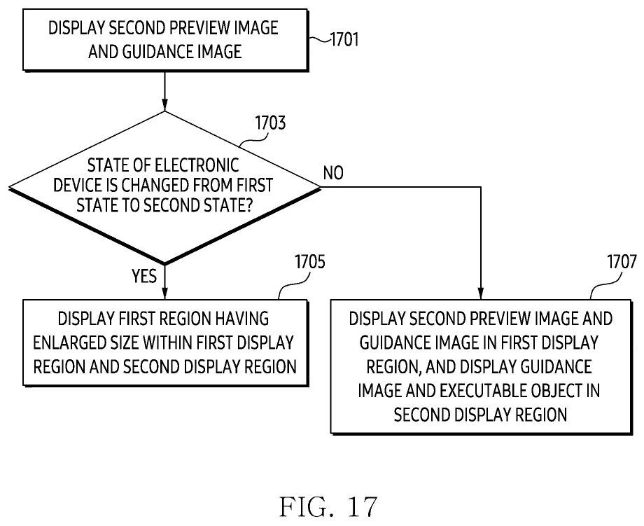

FIG. 17 illustrates an operation of identifying whether a first state is changed to a second state according to an embodiment of the disclosure. The operations exemplified through FIG. 17 may be executed by the electronic device 100 illustrated in FIG. 1, the electronic device 200 illustrated in FIG. 2, or the processor 210 of the electronic device 200 illustrated in FIG. 2.

Referring to FIG. 17, in operation 1701, the processor 210 may display the second preview image within the first region and display the guidance image within the second region. For example, operation 1701 may be executed while the electronic device 200 provides the landscape mode.

In operation 1703, the processor 210 may identify whether the state of the electronic device 200 providing the landscape mode is changed from the first state to the second state while the second preview image is displayed within the first region, and the guidance image is displayed within the second region. For example, the processor 210 may identify whether the first state is changed to the second state or the third state. For example, the processor 210 may execute operation 1705 based on the second state changed from the first state, and execute operation 1707 based on the third state changed from the first state.

In operation 1705, on a condition that the state of the electronic device 200 providing the landscape mode is changed to the second state, the processor 210 may display the first region having the enlarged size within the first display region and the second display region. For example, the processor 210 may provide the state 1650 of FIG. 16.

In operation 1707, on a condition that the state of the electronic device 200 providing the landscape mode is changed to the third state, the processor 210 may display the first region including the second preview image and the guidance image superimposed on the second preview image in the first display region (or the second display region), and display an executable object for control related to the guidance image and the second preview image in the second display region (or the first display region). The display in operation 1707 may be exemplified through FIG. 16.

Referring to FIG. 16, the processor 210 may display a UI 410 that includes a first region 420 including the second preview image 451 and a second region 430 including the remaining portion from among the guidance image 440 and the one or more thumbnail images 431, as shown in the state 450, while the electronic device 200 providing the landscape mode is in the first state. For example, the processor 210 may change the state 450 to a state 1670, in response to identifying the change from the first state to the third state.

In the state 1670, the UI 410 may include the first region 420 of the first region 420 and the second region 430. For example, the first region 420 may have an enlarged size than the first region 420 in the state 450. For example, the first region 420 may be displayed within the first display region and the second display region.

For example, the first region 420 may include a second preview image 451 displayed within the first display region (or the second display region). For example, a size of the second preview image 451 in the state 1670 may correspond to a size of the second preview image 451 in the state 450. For example, the size of the second preview image 451 in the state 1670 may be larger than the size of the second preview image 451 in the state 450. The size of the second preview image 451 in the state 1670 may be smaller than the size of the second preview image 451 in the state 450.

For example, the first region 420 may include the guidance image 440. For example, the guidance image 440 may be superimposed on the second preview image 451. For example, a size of the guidance image 440 superimposed on the second preview image 451 may be smaller than a size of the guidance image 440 in the state 450.

For example, the first region 420 may include the guidance image 440 displayed within the second display region (or the first display region). For example, unlike the first display region, the second display region may face a direction corresponding to a ground direction (or gravity direction) among the second display regions. For example, the guidance image 440 displayed within the second display region (or the first display region) may be separated from the second preview image 451 displayed within the first display region (or the second display region). For example, a size of the guidance image 440 displayed in the second display region (or the first display region) may be larger than a size of the guidance image 440 superimposed on the second preview image 451. However, it is not limited thereto.

For example, the first region 420 may include an executable object 422 or a set 426 of executable objects displayed within the second display region (or the first display region). For example, the executable object 422 or the set 426 of executable objects may be positioned next to the guidance image 440 displayed within the second display region (or the first display region).

Unlike the state 450 and the state 1650, two guidance images 440 may be displayed in the state 1670. For example, since the third state is a state in which a display region of the first display region and the second display region is used as an information providing region, and another display region of the first display region and the second display region is used as a control region, the processor 210 may display two guidance images 440 in the state 1670, which is the third state. For example, the electronic device 200 may display respectively two guidance images 440 in different display regions so that a user can conveniently access various controls. For example, the electronic device 200 may provide an enhanced photographing environment.

FIG. 16 illustrates an example in which the state 1670 is provided while providing the landscape mode, but this is for convenience of explanation. It should be noted that a state similar to the state 1670 may be provided while the electronic device 200 provides the portrait mode.

As described above, the electronic device 200 may display the UI capable of adaptively changing the display of the guidance image. The electronic device 200 may provide an enhanced photographing environment through the display of the UI.

As described above, an electronic device 200 may comprise a display 240, a plurality of cameras, and a processor 210. According to an embodiment of the disclosure, the processor 210 may be configured to display, via the display 240, within a first region 420 of a user interface (UI) 410 for photographing, a first preview image 421, representing a first scene, obtained through at least one of the plurality of cameras at a first magnification lower than a reference magnification, and display, via the display 240, within a second region 430 of the UI 410 different from the first region 420, one or more thumbnail images 431 respectively indicating one or more images obtained through at least one of the plurality of cameras. According to an embodiment of the disclosure, the processor 210 may be configured to, while the first preview image 421 and the one or more thumbnail images 431 are displayed within the UI 410, receive an input for changing the first magnification to a second magnification higher than or equal to the reference magnification. According to an embodiment of the disclosure, the processor 210 may be configured to, based on the input, display, via the display 240, within the first region 420, a second preview image 451 representing a second scene where a portion of the first scene is enlarged to the second magnification, and display, via the display 240, within the second region 430, a guidance image 440 indicating the second scene with respect to at least portion of the first scene.

According to an embodiment of the disclosure, the processor 210 may be configured to, based on the input, cease displaying a portion of the one or more thumbnail images 431 within the second region 430 and display the guidance image 440 within the second region 430.

According to an embodiment of the disclosure, the guidance image 440 may be visually highlighted relative to a remaining portion of the one or more thumbnail images 431 maintained within the second region 430 after the input is received.

According to an embodiment of the disclosure, the remaining portion of the one or more thumbnail images 431, maintained within the second region 430 after the input is received, unlike the guidance image 440, may be dimmed.

According to an embodiment of the disclosure, the processor 210 may be configured to, in response to a user input indicating to select the remaining portion of the one or more thumbnail images 431 from among the guidance image 440 and the remaining portion of the one or more thumbnail images 431, cease displaying the guidance image 440 within the second region 430 and display the guidance image 440 partially superimposed on the second preview image 451 displayed within the first region 420.

According to an embodiment of the disclosure, a size of the guidance image 440, partially superimposed on the second preview image 451, may be smaller than a size of the guidance image 440 displayed within the second region 430.

According to an embodiment of the disclosure, the processor 210 may be configured to, in response to the user input indicating to select the remaining portion of the one or more thumbnail images 431, resume displaying the portion of the one or more thumbnail images 431 within the second region 430.

According to an embodiment of the disclosure, the processor 210 may be configured to display the guidance image 440 superimposed on a second portion of the second preview image 451, different from a first portion of the second preview image 451, the first portion of the second preview image 451 including a visual object 470 corresponding to a subject focused within the second scene.

According to an embodiment of the disclosure, the processor 210 may be configured to identify the visual object 470 moved to the second portion of the second preview image 451. According to an embodiment of the disclosure, the processor 210 may be configured to, in response to the movement of the visual object, display the guidance image 440 superimposed on the first portion of the second preview image 451 or a third portion of the second preview image 451.

According to an embodiment of the disclosure, the processor 210 may be configured to, in response to a user input indicating to move the guidance image 440 within the second region 430 to the first region 420, cease displaying the guidance image 440 within the second region 430 and display the guidance image 440 partially superimposed on the second preview image 451 within the first region 420.

According to an embodiment of the disclosure, the guidance image 440 may be displayed, at a position where the user input is released, as superimposed on the second preview image 451.

According to an embodiment of the disclosure, a remaining portion of the one or more thumbnail images 431, maintained within the second region 430 after the user input is received, unlike the guidance image 440, may be blurred.

According to an embodiment of the disclosure, the processor 210 may be configured to, while the first preview image 421 is displayed within the first region 420 and the one or more thumbnail images 431 are displayed within the second region 430, receive an input for changing the first magnification to a third magnification that is higher than the first magnification and is lower than the reference magnification. According to an embodiment of the disclosure, the processor 210 may be configured to, based on the input for changing the first magnification to the third magnification, display, within the first region 420, a third preview image representing a third scene where a portion of the first scene is enlarged to the third magnification and maintain a display state of the second region 430.

According to an embodiment of the disclosure, the processor 210 may be configured to refrain from displaying the guidance image 440 within the second region 430, based on the third magnification less than the reference magnification.

According to an embodiment of the disclosure, the plurality of cameras 250 may include a first camera having a first field of view (FOV) and a first focal length, and a second camera having a second FOV and a second focal length, the second FOV narrower than the first FOV and the second focal length longer than the first focal length. According to an embodiment of the disclosure, each of the first preview image 421 and the guidance image 440 may be obtained based on at least a portion of a plurality of images obtained through the first camera from among the plurality of cameras. According to an embodiment of the disclosure, the second preview image 451 may be obtained based on at least a portion of a plurality of images obtained through the second camera from among the plurality of cameras.

According to an embodiment of the disclosure, the guidance image 440 may indicate the second scene with respect to a third scene where a portion of the first scene is enlarged to a third magnification higher than the first magnification and less than the reference magnification.

According to an embodiment of the disclosure, the third magnification may be identified based on the second magnification.

According to an embodiment of the disclosure, the guidance image 440 may include a visual element 441 for informing a position of the second scene within the at least portion of the first scene.

According to an embodiment of the disclosure, the processor 210 may be configured to, while the second preview image 451 is displayed within the first region 420 and the guidance image 440 is displayed within the second region 430, receive a user input on the guidance image 440 for changing a display state of the second preview image 451. According to an embodiment of the disclosure, the processor 210 may be configured to change a display state of the second preview image, based at least in part on the user input.

According to an embodiment of the disclosure, the processor 210 may be configured to change the display state of the second preview image 451 by changing brightness of the second preview image 451 based at least in part on the user input.

According to an embodiment of the disclosure, the processor 210 may be configured to change the display state of the second preview image 451 by controlling an auto exposure (AE) function of a camera related to the second preview image 451 from among the plurality of cameras, based at least in part on the user input.

According to an embodiment of the disclosure, the processor 210 may be configured to change the display state of the second preview image 451 by controlling an auto-focus (AF) function of a camera related to the second preview image 451 from among the plurality of cameras, based at least in part on the user input.

According to an embodiment of the disclosure, the processor 210 may be configured to change the display state of the second preview image 451 by changing an aspect ratio of the second preview image 451, based at least in part on the user input.

According to an embodiment of the disclosure, the processor 210 may be configured to change a display state of the guidance image 440 based at least in part on the user input.

According to an embodiment of the disclosure, the processor 210 may be configured to cease displaying the executable object in the first region 420 for changing the display state, based on the input.

According to an embodiment of the disclosure, the processor 210 may be configured to identify a position of the guidance image 440 to be displayed within the second region 430, based on a grip state of the electronic device 200, in response to the input. According to an embodiment of the disclosure, the processor 210 may be configured to display the guidance image 440 at the identified position within the second region 430.

According to an embodiment of the disclosure, the display 240 may include a flexible display including a first display region 241 and a second display region 242 adjacent to the first display region.

According to an embodiment of the disclosure, the processor 210 may be configured to, while the second preview image 451 is displayed within the first region 420 and the guidance image 440 is displayed within the second region 430, identify that a state of the electronic device 200 is changed from a first state in which an angle between a first direction toward which the first display region 241 faces and a second direction toward which the second display region 242 faces is within a reference range to a second state in which the angle is outside the reference range.

According to an embodiment of the disclosure, the processor 210 may be configured to, in response to the identification, cease displaying the second region 430, and display, within the first display region 241 and the second display region 242, the first region 420 having an enlarged size including the guidance image 440 partially superimposed on the second preview image 451 having an enlarged size.

According to an embodiment of the disclosure, the processor 210 may be configured to, while the first region 420 having the enlarged size is displayed, identify that the state of the electronic device 200 is restored to the first state. According to an embodiment of the disclosure, the processor 210 may be configured to, in response to identifying that the state of the electronic device 200 is restored to the first state, display the second preview image 451 within the first region 420 and display the guidance image 440 within the second region 430.

According to an embodiment of the disclosure, the processor 210 may be configured to, while the second preview image 451 is displayed within the first region 420 and the guidance image 440 is displayed within the second region 430, identify whether the state of the electronic device 200 providing a landscape mode is changed from the first state to a state different from the first state. According to an embodiment of the disclosure, the processor 210 may be configured to, in response to identifying that the state of the electronic device 200 providing the landscape mode is changed from the first state to a second state in which the angle is outside the reference range and another reference range, display, within the first display region 241 and the second display region 242, the first region 420 having the enlarged size. According to an embodiment of the disclosure, the processor 210 may be configured to, in response to identifying that the state of the electronic device 200 providing the landscape mode is changed from the first state to a third state in which the angle is outside the reference range and within the other reference range, cease displaying the second region 430, display, within the first display region 241, the first region 420 including the second preview image 451 and the guidance image 440 superimposed on the second preview image 451, and display, within the second display region 242, an executable object for control related to the guidance image 440 and the second preview image 451.

According to an embodiment of the disclosure, the first preview image 421, the second preview image 451, and the guidance image 440 may be displayed while obtaining a video through at least one of the plurality of cameras.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a plurality of cameras;
at least one processor comprising processing circuitry; and
memory comprising one or more storage media storing instructions that, when executed by the at least one processor individually or collectively, cause the electronic device to:
display, via the display, within a first region of a user interface (UI) for photographing, a first preview image of a first scene obtained through at least one of the cameras at a first magnification lower than a reference magnification, and display, via the display, within a second region of the UI different from the first region, one or more thumbnail images respectively indicating one or more images obtained through at least one of the cameras;
while the first preview image and the one or more thumbnail images are concurrently displayed within the UI, receive an input for changing the first magnification to a second magnification higher than the reference magnification; and
based on the input, display, via the display, within the first region, a second preview image of a second scene where a portion of the first scene is enlarged to the second magnification, and display, via the display, within the second region, a guidance image indicating the second scene with respect to at least portion of the first scene.

2. The electronic device of claim 1, wherein the instructions, when executed by the at least one processor individually or collectively, cause the electronic device to:
based on the input, cease displaying a portion of the one or more thumbnail images within the second region and display the guidance image within the second region.

3. The electronic device of claim 2, wherein the guidance image is visually highlighted relative to a remaining portion of the one or more thumbnail images maintained within the second region after the input is received.

4. The electronic device of claim 2, wherein the remaining portion of the one or more thumbnail images, maintained within the second region after the input is received, is dimmed.

5. The electronic device of claim 4, wherein the instructions, when executed by the at least one processor individually or collectively, cause the electronic device to:
in response to a user input indicating to select the remaining portion of the one or more thumbnail images from among the guidance image and the remaining portion of the one or more thumbnail images, cease displaying the guidance image within the second region and display the guidance image partially superimposed on the second preview image displayed within the first region.

6. The electronic device of claim 5, wherein a size of the guidance image, partially superimposed on the second preview image, is smaller than a size of the guidance image displayed within the second region.

7. The electronic device of claim 5, wherein the instructions, when executed by the at least one processor individually or collectively, cause the electronic device to:
in response to the user input indicating to select the remaining portion of the one or more thumbnail images, resume displaying the portion of the one or more thumbnail images within the second region.

8. The electronic device of claim 5, wherein the instructions, when executed by the at least one processor individually or collectively, cause the electronic device to display the guidance image superimposed on a second portion of the second preview image, different from a first portion of the second preview image, the first portion of the second preview image including a representation of a subject focused within the second scene.

9. The electronic device of claim 8, wherein the instructions, when executed by the at least one processor individually or collectively, cause the electronic device to:
identify the representation moved to the second portion of the second preview image, and
in response to the movement of the representation, display the guidance image superimposed on the first portion of the second preview image or a third portion of the second preview image.

10. The electronic device of claim 4, wherein the instructions, when executed by the at least one processor individually or collectively, cause the electronic device to:
in response to a user input indicating to move the guidance image within the second region to the first region, cease displaying the guidance image within the second region and display the guidance image partially superimposed on the second preview image within the first region.

11. The electronic device of claim 10, wherein the guidance image is displayed, at a position where the user input is released, as superimposed on the second preview image.

12. The electronic device of claim 2, wherein a remaining portion of the one or more thumbnail images, maintained within the second region after the user input is received, is blurred.

13. The electronic device of claim 1, wherein the instructions, when executed by the at least one processor individually or collectively, cause the electronic device to:
while the first preview image is displayed within the first region and the one or more thumbnail images are displayed within the second region, receive an input for changing the first magnification to a third magnification that is higher than the first magnification and is lower than the reference magnification; and
based on the input for changing the first magnification to the third magnification, display, within the first region, a third preview image representing a third scene where a portion of the first scene is enlarged to the third magnification and maintain a display state of the second region.

14. The electronic device of claim 13, wherein the instructions, when executed by the at least one processor individually or collectively, cause the electronic device to:
based on the third magnification lower than the reference magnification, refrain from displaying the guidance image within the second region.

15. The electronic device of claim 1, wherein the cameras include:
a first camera having a first field of view (FOV) and a first focal length, and a second camera having a second FOV narrower than the first FOV and a second focal length longer than the first focal length,
wherein each of the first preview image and the guidance image is obtained based on at least a portion of a plurality of images through the first camera from among the cameras, and
wherein the second preview image is obtained based on at least a portion of a plurality of images obtained through the second camera from among the cameras.

16. The electronic device of claim 1, wherein the guidance image indicates the second scene with respect to a third scene where a portion of the first scene is enlarged to a third magnification higher than the first magnification and lower than the reference magnification.

17. The electronic device of claim 16, wherein the third magnification is identified based on the second magnification.

18. The electronic device of claim 1, wherein the guidance image includes a visual element for informing a position of the second scene in at least the portion of the first scene.

19. A method executed in an electronic device including a display and a plurality of cameras, the method comprising:
displaying, via the display, within a first region of a user interface (UI) for photographing, a first preview image of a first scene obtained through at least one of the cameras at a first magnification lower than a reference magnification, and displaying, via the display, within a second region of the UI different from the first region, one or more thumbnail images respectively indicating one or more images obtained through at least one of the cameras;
while the first preview image and the one or more thumbnail images are concurrently displayed within the UI, receiving an input for changing the first magnification to a second magnification higher than the reference magnification; and
based on the input, displaying, via the display, within the first region, a second preview image of a second scene where a portion of the first scene is enlarged to the second magnification, and displaying, via the display, within the second region, a guidance image indicating the second scene with respect to at least portion of the first scene.

20. A non-transitory computer readable storage medium storing one or more programs, the one or more programs including instructions, when executed by an electronic device with a display and a plurality of cameras, to cause the electronic device to:
display, via the display, within a first region of a user interface (UI) for photographing, a first preview image of a first scene obtained through at least one of the cameras at a first magnification lower than a reference magnification, and display, via the display, within a second region of the UI different from the first region, one or more thumbnail images respectively indicating one or more images obtained through at least one of the cameras;
while the first preview image and the one or more thumbnail images are concurrently displayed within the UI, receive an input for changing the first magnification to a second magnification higher than or equal to the reference magnification; and
based on the input, display, via the display, within the first region, a second preview image of a second scene where a portion of the first scene is enlarged to the second magnification, and display, via the display, within the second region, a guidance image indicating the second scene with respect to at least portion of the first scene.
